(19) United States
(12) Patent Application Publication
(10) Pub. No.: US 2003/0197830 A1
(43) Pub. Date: Oct. 23, 2003

(54) Double-fronted eyeglass frame

(76) Inventor: Masanobu Taniguchi, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 10/299,860

(22) Filed: Nov. 20, 2002

(30) Foreign Application Priority Data
Apr. 23, 2002 (JP) 2002-2292

(51) Int. Cl. G02C 9/00; G02C 7/08

(52) U.S. Cl. 351/47

(57) ABSTRACT

Disclosed is a double-fronted eyeglass frame comprising an eyeglass frame having a front and two temples hinged to its opposite side joints, and a detachable front to be detachably attached to the front of the eyeglass frame. The bridge of the front of the eyeglass frame has magnets fixed to its opposite rear extensions, and likewise, the bridge of the detachable front has magnets fixed to its opposite rear extensions. The bridge of either front has guide pieces attached to its rear extensions, thereby permitting the magnets of the detachable front to be put on those of the front in correct position when the detachable front is hung on the front of the eyeglass frame.

### BACKGROUND OF THE INVENTION

1. Field of the Invention

The present invention relates to a double-fronted eyeglass frame, which has a detachable front attached to its front.

2. Related Arts

Double-fronted eyeglasses have been widely used. When those who are shortsighted want to wear sunglasses, or when those whose eyes get dim with age want to wear eyeglasses for short sight, they use detachable fronts having colored lenses fitted in their rims to be attached to their short-sight eyeglasses or detachable fronts having lenses for short sight to be attached to their eyeglasses for elderly people.

Conventional detachable fronts, however, have some defects as for example follows: their fastening parts are complicated in structure, and accordingly the manufacturing cost is high; and the fitting-on state is apt to be loosened with time, causing the detachable fronts to be unstable in position.

FIG. 5(a) shows a pair of eyeglasses of the type of allowing a detachable front “b” to be attached to its front “c” whereas FIG.5(b) shows the detachable front “b”. The front “c” has magnets “e” of one polarity attached to its opposite side joints “d” whereas the detachable front “b” has magnets “g” of the other polarity attached to its side joints “f”.

When the detachable front “b” is laid on the front “c” of the frame “a”, the detachable front “b” is fastened to the front “c” of the frame “a” by allowing their magnets of the opposite polarities to come close to each other. Needless to say, either front is provided with some means for preventing deviation of the detachable front “b” from the front “c” of the frame “a”. Japan Patent U3,081,271 shows such a double-fronted eyeglasses.

Japan Patent 9-101489(A) shows a detachable front fastening device, which comprises magnets of the opposite polarities embedded both in the opposite side joints of the front of the eyeglasses and in those of the detachable front, thereby fastening the opposite side joints of the detachable front to those of the eyeglasses front magnetically. Such fastening structure, however, requires that the detachable front be provided with extra side joints, and accordingly the manufacturing cost is high.

### SUMMARY OF THE INVENTION

One object of the present invention is to provide a double-fronted eyeglass frame capable of holding a detachable front on its front in a stable way.

Another object of the present invention is to provide a double-fronted eyeglass frame which is simple in structure and least expensive.

To attain these objects an eyeglass frame comprising a front and two temples hinged to its opposite side joints, and a detachable front to be detachably attached to the front of the eyeglasses, is improved according to the present invention in that: the bridge of the front of the eyeglass frame has magnets fixed to its opposite ends; the bridge of the detachable front has magnets fixed to its opposite ends; and one of the bridges has guide means to permit the magnets of the detachable front to be put on those of the front of the eyeglass frame in correct position when the detachable front is hung on the front of the eyeglasses.

The bridge of the front of the eyeglass frame has two rear extensions projecting from its opposite ends, the magnets being fixed to the rear extensions; and the bridge of the detachable front has two rear extensions projecting from its opposite ends, the magnets being fixed to the rear extensions; and the rear extensions of the bridge of the front of the eyeglass frame or the rear extensions of the bridge of the detachable front have semicircular guide pieces fixed to their circumferences.

Other objects and advantages of the present invention will be understood from the following description of a double-fronted eyeglass frame according to one embodiment of the present invention, which is shown in accompanying drawings.

### BRIEF DESCRIPTION OF THE DRAWING

FIG.1 is a perspective view of a detachable front according to one embodiment of the present invention;

FIG.2 is a perspective view of a pair of eyeglasses having a detachable front attached to its front according to one embodiment of the present invention;

FIG.3 is a perspective view each of the pair of eyeglasses and the detachable front;

FIG.4 illustrates, in section, the magnet-and-side joint of the front of the eyeglass frame and the overlying magnet-and-side joint of the detachable front; and

FIG.5(a) shows a conventional pair of double-fronted eyeglasses whereas FIG.5(b) shows a detachable front.

### DETAILED DESCRIPTION OF PREFERRED EMBODIMENT

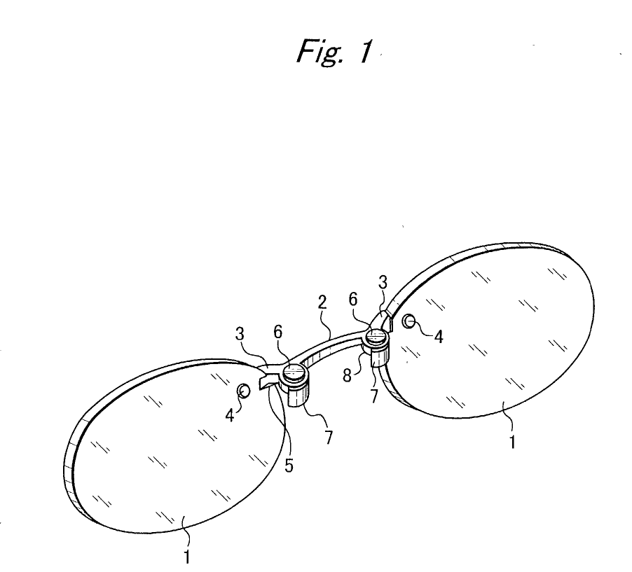

FIG.1 illustrates a detachable front according to the present invention as viewed from its rear side. As shown, the detachable front has two lenses 1, 1 connected by a bridge 2. Specifically the bridge 2 is fixed to the rimless lenses 1, 1 by fastening its opposite bifurcated sections 3, 3 to the inner sides of the lenses 1, 1 by screws 4, 4.

To prevent the lenses 1, 1 from turning about their pivot screws each lens 1 has a notch 5 made on its inner side, thereby permitting the minor bifurcation of the bifurcated section 3 to be caught by the notch 5. Alternatively, the fastening section comprises an extra pin projecting from each end of the bridge, and the lens has a hole made on its inner side. Thus, each end of the bridge has its extra pin inserted in the hole of each lens, thereby preventing the lens from turning about its screw pivot.

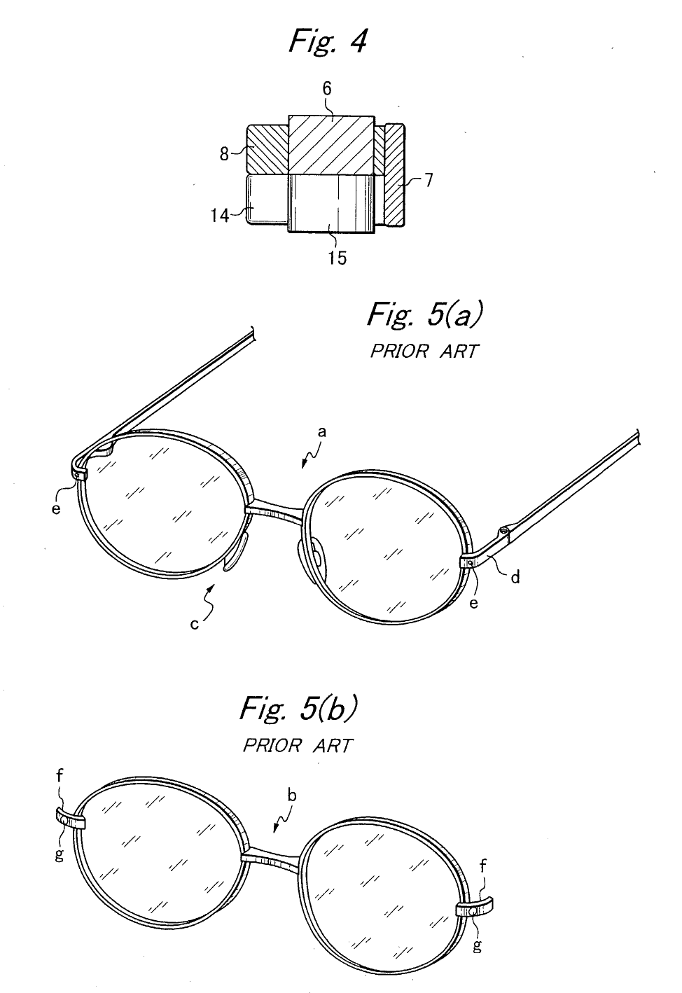

The bridge 2 of the detachable front has magnets 6, 6 fixed to its opposite rear extensions 8, 8. Specifically, each magnet 6 is set on the rear extension 8 of each end of the bridge 2 by press-fitting the magnet 6 in the hole made in the rear extension 8. In addition, the bridge 2 has semicircular guide pieces 7, 7 fixed to its rear extensions. As seen from FIGS. 1 and 4, each guide piece 7 extends a short distance down from the lower surface of the rear extension 8.

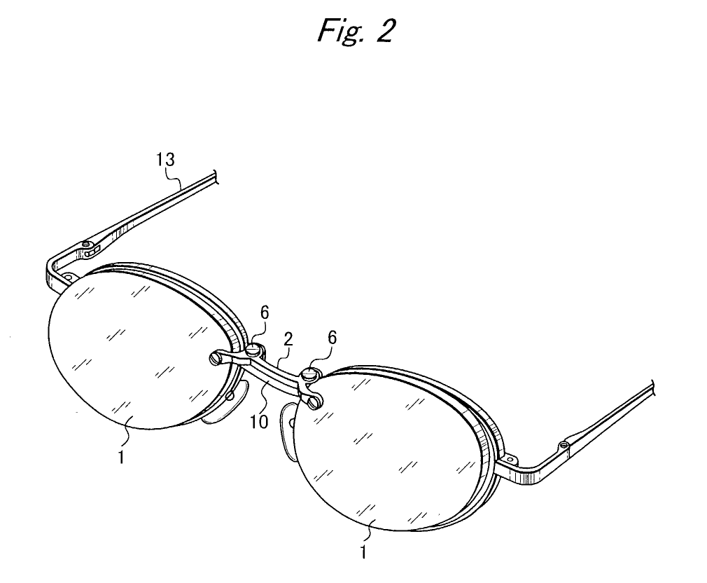

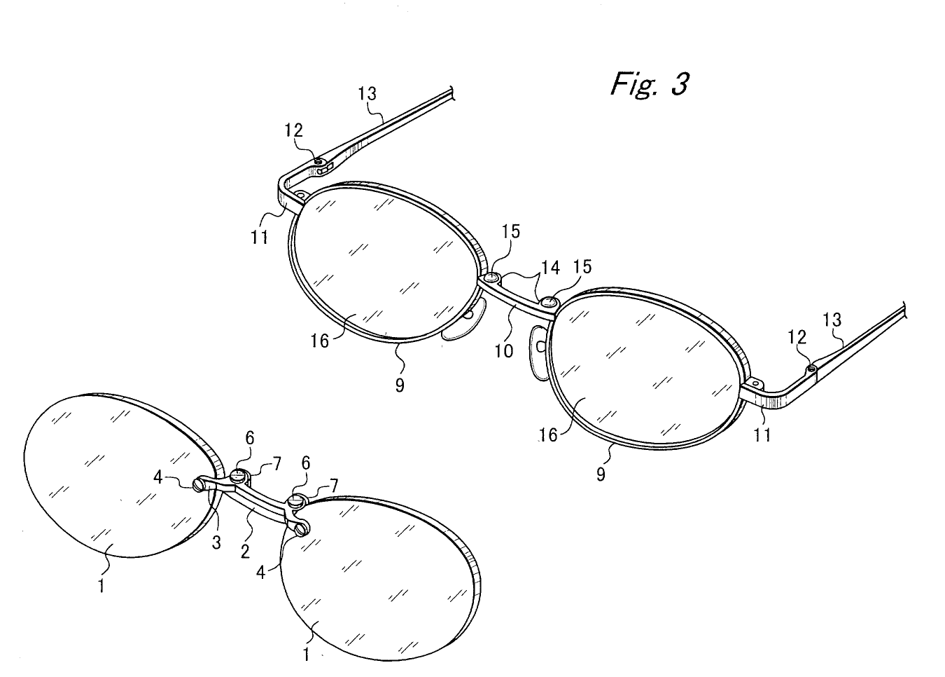

FIG.2 illustrates that the detachable front is hung from the front of an eyeglasses whereas FIG.3 illustrates that the detachable front is removed from the front of the eyeglasses. As shown, the eyeglass frame comprises rims 9, 9 jointed each other with a bridge 10 by soldering and the opposite temples 13, 13 hinged to the side joints 11, 11 of the rims.

As seen from these drawings, rear extensions 14, 14 project rearward from the opposite ends of the bridge 10, and magnets 15, 15 are press-fitted in the holes made in the rear extensions 14, 14. The magnet 15 is flush with the upper surface of the bridge 10, and the bridge 2 of the detachable front can be put on the bridge 10 of the front of the eyeglass frame. Then, the detachable front can be fastened to the front of the eyeglass frame by magnetically pulling toward each other.

The semicircular guide pieces 7, 7 of the rear extensions 8, 8 of the bridge 2 of the detachable front abut on the outer circumferences of the rear extensions 14, 14 of the bridge 10 of the front of the eyeglass frame so that the bridge 2 of the detachable front may be laid rightly on the bridge 10 of the front of the eyeglass frame with the lenses 1, 1 of the detachable front confronting those 16, 16 of the eyeglasses.

FIG.4 shows the manner in which each rear projection 8 and the magnet 6 of the detachable front are put on the corresponding rear projection 14 and the counter magnet 15 of the front of the eyeglass frame, and the manner in which the guide piece 7 helps the detachable front to remain in correct position relative to the front of the eyeglass frame. Also the guide piece 7 prevents the detachable front from falling off from the front of the eyeglass frame. The guide piece 7 is shown as being fixed to the detachable front in this particular embodiment, but alternatively it can be fixed to the outer circumference of each rear extension 14 of the bridge 10 of the front of the eyeglass frame. Then, it rises from the outer circumference of each rear extension 14.

As may be understood from the above, the eyeglass frame according to the present invention permits a detachable front to be magnetically attached to its front in stable way.

What is claimed is:

1. A double-fronted eyeglass frame comprising an eyeglass frame having a front and two temples hinged to its opposite side joints, and a detachable front to be detachably attached to the front of the eyeglass frame, wherein the bridge of the front of the eyeglass frame has magnets fixed to its opposite ends; the bridge of the detachable front has magnets fixed to its opposite ends; and one of the bridges has guide means to permit the magnets of the detachable front to be put on those of the front of the eyeglass frame in correct position when the detachable front is hung on the front of the eyeglasses.

2. A double-fronted eyeglass frame according to claim 1, wherein the bridge of the front of the eyeglass frame has two rear extensions projecting from its opposite ends, the magnets being fixed to the rear extensions; and the bridge of the detachable front has two rear extensions projecting from its opposite ends, the magnets being fixed to the rear extensions; and the rear extensions of the bridge of the front of the eyeglass frame or the rear extensions of the bridge of the detachable front have semicircular guide pieces fixed to their circumferences.
